(19) United States
(12) Patent Application Publication
(10) Pub. No.: US 2008/0209003 A1
(43) Pub. Date: Aug. 28, 2008

(54) MONITORING DEVICE AND MONITORING METHOD

(75) Inventors: Hideki Mitsunobu, Kawasaki (JP); Takao Mohri, Kawasaki (JP); Yuji Wada, Kawasaki (JP); Satoru Takahashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/037,122

(22) Filed: Feb. 26, 2008

(30) Foreign Application Priority Data
Feb. 27, 2007 (JP) 2007-047338

(51) Int. Cl. G06F 15/167

(52) U.S. Cl. 709/216

(57) ABSTRACT

A computer executes a monitoring control by receiving a first notification which has been transmitted from another communication apparatus to a network, and acquiring first identification information which is identification information of the communication apparatus at a predetermined first layer, from the first notification. The computer acquires second identification information which is identification information of the communication apparatus at a second layer being lower in hierarchy than the first layer. The computer associates the first identification information and the second identification information, and acquires a connection state between the network and the communication apparatus at the second layer.

### BACKGROUND

1. Technical Field

A monitoring device and a monitoring method by which another communication apparatus is notified of the connection of a certain communication apparatus to a network.

2. Description of the Related Art

A ubiquitous environment requires a scheme which cooperates with services and equipments that subsist in a particular place. At present, notice is taken of the UPnP (Universal Plug and Play) as standard technology for the cooperation.

The operation of UPnP equipment is described.

First, the existence notification (ALIVE) of the UPnP equipment is explained.

Incidentally, the UPnP equipment which is to be handled shall be called “UPnP equipment to-be-handled” in the description of the related art. A network to which the UPnP equipment to-be-handled is connected shall be called “network to-be-handled”.

The UPnP equipment to-be-handled transmits existence notification to the network to-be-handled by multicasting during the connection of the UPnP equipment to-be-handled to the network to-be-handled. The notification indicates the existence of the UPnP equipment to-be-handled to other UPnP equipment located within the network to-be-handled.

The existence notification bears a term during which the UPnP equipment to-be-handled will be available. The UPnP equipment to-be-handled transmits the existence notification again before the available term expires. The other UPnP equipment, having received the existence notification, regards the UPnP equipment to-be-handled as existing during the available term. The other UPnP equipment regards the UPnP equipment to-be-handled as having gone out of existence upon the expiration of the available term.

Next, the stop notification (BYEBYE) of the UPnP equipment is explained. When the UPnP equipment to-be-handled is to be detached from the network to-be-handled, it transmits the stop notification by multicasting to the network to-be-handled. The other UPnP equipment, having received the stop notification, regards the UPnP equipment to-be-handled as having gone out of existence, even when the available term remains.

Incidentally, as a related-art technique relevant to some embodiments, there has been a network apparatus wherein individual devices within a network manage information items found out about one another as a list. The information items are shared by notifying the devices of disconnection from the network and like changes, so as to periodically confirm the existences of the devices (refer to, for example, JP-A-2004-318852).

However, the existence/stop notifications of the UPnP are not interlocked with the connection/detachment to and from the network. Therefore, when the UPnP equipment to-be-handled is detached without sending the stop notification, the other UPnP equipment regards the UPnP equipment to-be-handled as existing until the available term expires. In a case, for example, in which the UPnP equipment to-be-handled is connected to the network by radio communications, the UPnP equipment to-be-handled is detached from the network without sending the stop notification when it goes out of the area of the radio communications. If the ordinary available term is set at, for example, 30 minutes, the other UPnP equipment regards the UPnP equipment to-be-handled as existing for up to 30 minutes.

Moreover, even when the detachment of the UPnP equipment to-be-handled has been recognized at a layer lower in the network hierarchy than an UPnP layer, the lower layer and the UPnP layer are not interlocked. Therefore UPnP layer needs to recognize the detachment of the UPnP equipment to-be-handled by itself.

With the technique of JP-A-2004-318852 mentioned above, all the devices monitor one another at all times, so that the load of all the UPnP equipments is heavy. In a case where the UPnP equipment to-be-handled is battery-driven, the operating time period of the UPnP equipment to-be-handled shortens when the loads of a CPU and the radio communications are increased.

### SUMMARY OF THE INVENTION

In view of the above-mentioned drawbacks, the embodiments has for its object to provide a monitoring program, a monitoring device and a monitoring method in which, when a communication equipment to-be-handled is detached from a network, another equipment located within the network can promptly recognize the detachment.

In one aspect of performance, a computer executes a monitoring control including:

receiving a first notification which has been transmitted from another communication apparatus to a network, and acquiring first identification information which is identification information of the communication apparatus at a predetermined first layer, from the first notification;
acquiring second identification information which is identification information of the communication apparatus at a second layer being lower in hierarchy than the first layer, and associating the first identification information and the second identification information;
acquiring a connection state between the network and the communication apparatus at the second layer; and
generating a second notification which indicates that the communication apparatus has been detached from the network, on the basis of the first identification information corresponding to the second identification information, in a case where the computer has judged the detachment of the communication apparatus from the network, on the basis of the connection state and the second identification information, and transmitting the second notification to the network.

The above-described embodiments of the present invention are intended as examples, and all embodiments of the present invention are not limited to including the features described above.

### BRIEF DESCRIPTION OF THE DRAWINGS

FIG. 1 is a block diagram showing an example of the configuration of an UPnP communication system according to an embodiment of the embodiments;

FIG. 2 is a table showing an example of the contents of terminal connection information according to the embodiment;

FIG. 3 is a table showing an example of the contents of UPnP information according to the embodiment;

FIG. 4 is a table showing an example of the contents of a translation table according to the embodiment;

FIG. 5 is a flow chart showing an example of the preparatory operation of the UPnP communication system according to the embodiment;

FIG. 6 is a flow chart showing an example of the periodic operation of the UPnP communication system according to the embodiment; and

FIG. 7 is a flow chart showing an example of the detection operation of the UPnP communication system according to the embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Now, the configuration and operation of one embodiment is described with reference to the drawings.

Incidentally, the embodiment is described on an UPnP communication system to which a monitoring device is applied.

First, the configuration of the UPnP communication system according to the embodiment is described.

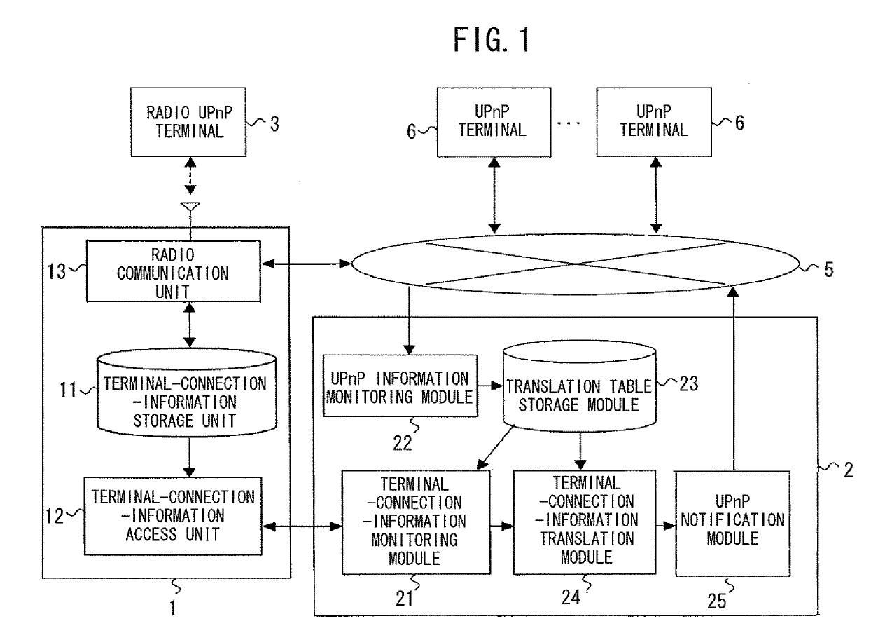

FIG. 1 is a block diagram showing an example of the configuration of the UPnP communication system according to the embodiment.

The UPnP communication system includes an AP (Access Point, namely, radio access point) 1, a monitoring device 2, a radio UPnP terminal (communication apparatus) 3, a network 5 and other UPnP terminals 6. The radio LAN-AP 1 and the monitoring device 2 are connected by wire. The AP 1 is the access point of a radio LAN (Local Area Network), and it is connected with the radio UPnP terminal 3 by radio. The AP 1, the monitoring device 2 and the UPnP terminals 6 are connected through the network 5.

The AP 1 includes a terminal-connection-information storage unit (storage medium) 11, a terminal-connection-information access unit 12 and a radio communication unit 13. The radio communication unit 13 performs radio communications with the radio UPnP terminal 3 and the like terminals belonging to the radio LAN. The radio communication unit 13 stores the information items of the terminals connected to the radio LAN, in the terminal-connection-information storage unit 11 as terminal connection information (connection states). The radio communication unit 13 manages terminal connection information. The terminal connection information is information which has been managed for the radio LAN in a conventional AP.

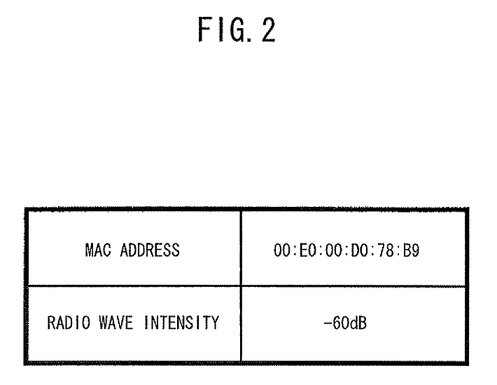

FIG. 2 is a table showing an example of the contents of the terminal connection information according to the embodiment. As indicated in the table, the terminal connection information is the information of the lower layer (MAC layer) of each terminal belonging to the radio LAN, and it contains a MAC address (second identification information) and a radio wave intensity received from the terminal. The terminal-connection-information access unit 12 transmits the terminal connection information stored in the terminal-connection-information storage unit 11, to the monitoring device 2 in compliance with a request from the monitoring device 2.

The software of the monitoring device 2 includes a terminal-connection-information monitoring module 21, an UPnP information monitoring module 22, a translation table storage module 23, a terminal-connection-information translation module 24 and an UPnP notification module 25. The hardware of the monitoring device 2 is, for example, a server, and it includes a CPU and a storage unit. The individual modules of the software of the monitoring device 2 are the functions of a monitoring program stored in the storage unit of the monitoring device 2, and they are incarnated on the storage unit of the monitoring device 2 by the CPU of the monitoring device 2.

The terminal-connection-information monitoring module 21 requests the terminal-connection-information access unit 12 to transmit the terminal connection information, thereby to acquire the terminal connection information from the terminal-connection-information access unit 12. The UPnP information monitoring module 22 acquires UPnP information (first identification information) from a UPnP message (existence notification) transmitted from the radio UPnP terminal 3 and also acquires the MAC address of the radio UPnP terminal 3 therefrom, and it stores the UPnP information and the MAC address in the translation table storage module 23 as the translation table.

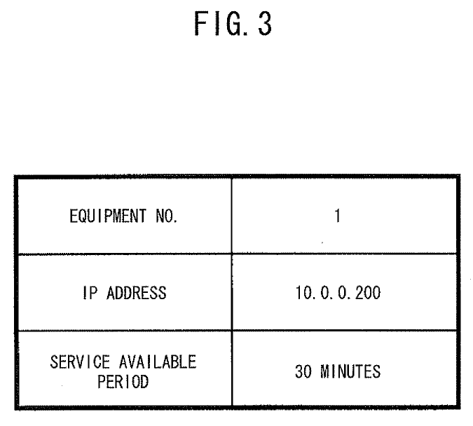

FIG. 3 is a table showing an example of the contents of the UPnP information according to the embodiment. As indicated in the table, the UPnP information is the information of the UPnP layer of each UPnP terminal, and it contains an equipment No., an IP address and a service available period (available term).

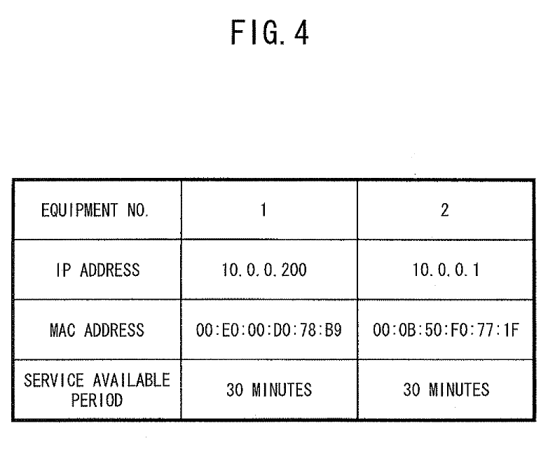

FIG. 4 is a table showing an example of the contents of the translation table according to the embodiment. As indicated in the table, the translation table stores therein the values of equipment Nos. (IDs), IP addresses, MAC addresses and service available periods every UPnP.

The terminal-connection-information translation module 24 translates the terminal connection information acquired by the terminal-connection-information monitoring module 21, into the UPnP information on the basis of the translation table stored in the translation table storage module 23. The UPnP notification module 25 transmits a UPnP message (stop notification) indicating the detachment of the radio UPnP terminal 3, to the network 5 as proxy for the radio UPnP terminal 3 on the basis of the UPnP information translated by the terminal-connection-information translation module 24.

The radio UPnP terminal 3 and the UPnP terminals 6 are terminals conforming to the UPnP standards, and they are respectively equivalent to conventional radio UPnP terminal and UPnP terminals.

Next, the preparatory operation of the UPnP communication system according to the embodiment is described.

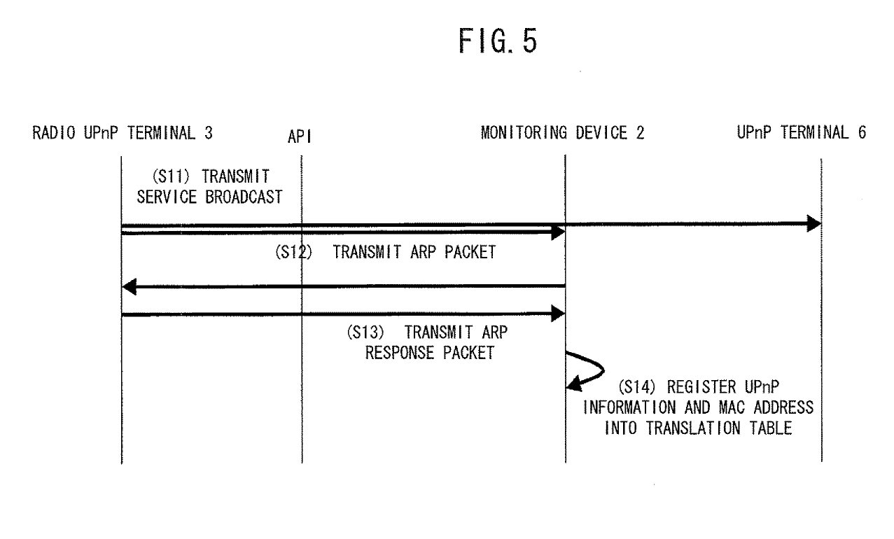

The preparatory operation is an operation which is performed at the point of time when the radio UPnP terminal 3 has been connected to the AP 1. FIG. 5 is a flow chart showing an example of the preparatory operation of the UPnP communication system according to the embodiment. First, when the radio UPnP terminal 3 is connected to the AP 1, thereby to be connected to the network 5, it transmits a service broadcast (existence notification) for notifying UPnP service contents to all the UPnP terminals 6 and the monitoring device 2 connected to the network 5, by broadcasting (S11). The monitoring device 2 having received the service broadcast transmits an ARP (Address Resolution Protocol) packet to the transmission source of the service broadcast (S12). The radio UPnP terminal 3 having received the ARP packet transmits an ARP response packet containing the MAC address of its own, to the monitoring device 2 (S13). The monitoring device 2 having received the ARP response packet associates the UPnP information contained in the service broadcast and the MAC address of the radio UPnP terminal 3 contained in the ARP response packet, and registers them as the record of the translation table in the translation table storage module 23 (S14). Then, the preparatory operation is ended.

In accordance with the above preparatory operation, the monitoring device 2 can associate the UPnP information and MAC address of the radio UPnP terminal 3.

Next, the periodic operation of the UPnP communication system according to the embodiment is described.

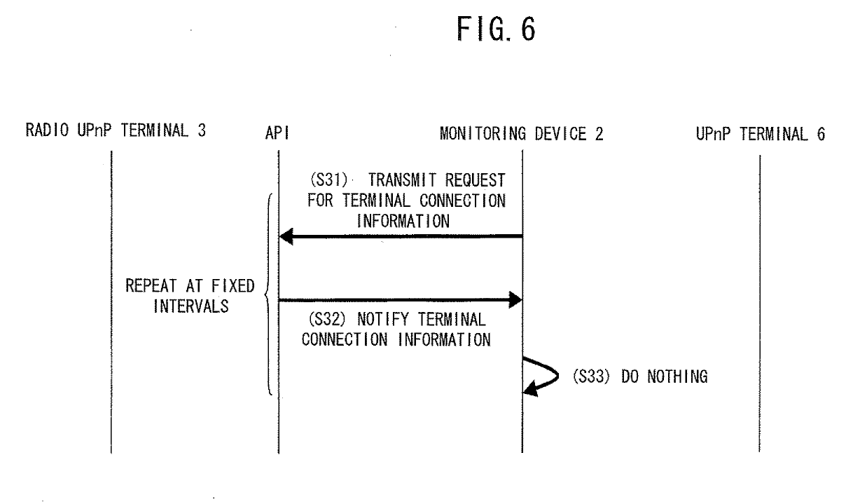

The periodic operation is an operation which is repeatedly performed at confirmation intervals (predetermined time intervals) being preset time periods, while the radio UPnP terminal 3 is connected to the AP 1 after the preparatory operation. The confirmation intervals are time periods being sufficiently shorter than the service available period, and they are, for example, several seconds. FIG. 6 is a flow chart showing an example of the periodic operation of the UPnP communication system according to the embodiment. First, the terminal-connection-information monitoring module 21 of the monitoring device 2 transmits a request for the terminal connection information, to the AP 1 (S31). The terminal-connection-information access unit 12 of the AP 1 having received the request acquires the terminal connection information stored in the terminal-connection-information storage unit 11, and transmits the acquired information to the monitoring device 2 (S32) Here, it is assumed that the radio UPnP terminal 3 is connected to the AP 1. The terminal-connection-information monitoring module 21 of the monitoring device 2 judges that the radio UPnP terminal 3 is connected to the AP 1, on the basis of the received terminal connection information, and it ends the periodic operation without doing anything (S33), After the confirmation interval, the periodic operation is performed again.

At the process operation S32, the terminal-connection-information access unit 12 transmits the terminal connection information items of all the terminals stored in the terminal-connection-information storage unit 11. It is also allowed that, at the process operation S31, the terminal-connection-information monitoring module 21 makes a request for the terminal connection information of the MAC address stored in the translation table storage module 23, and that, at the process operation S32, the terminal-connection-information access unit 12 transmits only the terminal connection information of the requested terminal.

Next, the detection operation of the UPnP communication system according to the embodiment is described.

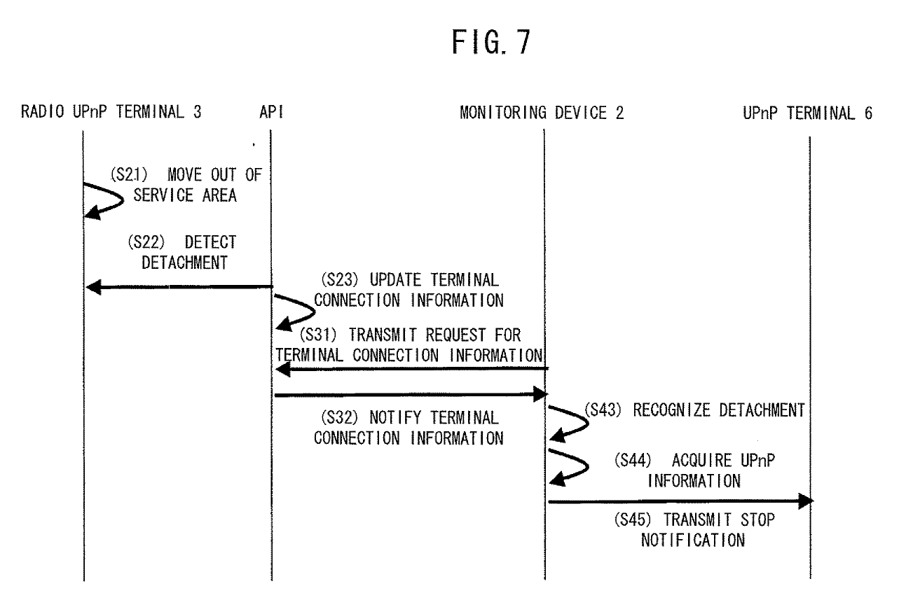

The detection operation is an operation in the case where the radio UPnP terminal 3 has been detached from the AP 1 after the preparatory operation. FIG. 7 is a flow chart showing an example of the detection operation of the UPnP communication system according to the embodiment. First, when the radio UPnP terminal 3 moves out of the service area of the AP 1 (S21), the radio communication unit 13 of the AP 1 detects the detachment of the radio UPnP terminal 3 from the radio LAN (S22). The radio communication unit 13 updates the terminal connection information in the terminal-connection-information storage unit 11 (S23). Here, the radio communication unit 13 deletes the terminal connection information of the terminal detached from the radio LAN. It is also allowed that information items indicating whether or not each terminal is connected are contained in the terminal connection information, and that the radio communication unit 13 updates the information items.

Subsequently, it is assumed that the terminal-connection-information monitoring module 21 of the monitoring device 2 has transmitted a request for the terminal connection information, to the AP 1 by the periodic operation described before (S31). The terminal-connection-information access unit 12 of the AP 1 having received the request acquires the terminal connection information stored in the terminal-connection-information storage unit 11, and transmits the acquired information to the monitoring device 2 (S32). The terminal-connection-information monitoring module 21 of the monitoring device 2 recognizes that the radio UPnP terminal 3 has been detached from the network 5, from the received terminal connection information (S43). Besides, the terminal-connection-information monitoring module 21 compares the MAC address registered in the translation table and the MAC address in the terminal connection information, and judges that the terminal of the MAC address which is not contained in the terminal connection information has been detached from the network 5.

Subsequently, the terminal-connection-information translation module 24 of the monitoring device 2 acquires the UPnP information corresponding to the MAC address of the detached radio UPnP terminal 3, by referring to the translation table (S44). The UPnP notification module 25 of the monitoring device 2 generates an UPnP message (stop notification) indicating that the radio UPnP terminal 3 has been detached from the network 5, by using the acquired UPnP information. The UPnP notification module 25 transmits the message to the network 5 by broadcasting (S45). Then, the detection operation is ended.

In accordance with the periodic operation and the detection operation described above, the monitoring device 2 acquires information managed by the AP 1, whereby the detachment of the radio UPnP terminal 3 from the network 5 is detected. In addition, the monitoring device 2 transmits a stop notification to the network 5, instead of the radio UPnP terminal 3, whereby the UPnP terminal 6 connected to the network 5 can promptly recognize the detachment of the radio UPnP terminal 3 from the network 5. In the related-art UPnP communication system, a delay until a UPnP terminal recognizes the detachment of a radio UPnP terminal becomes, at most, the available term of an existence notification, whereas in the UPnP communication system according to the embodiment, the delay becomes, at most, a confirmation interval.

Thus, when the embodiment and the related-art technique are compared, the AP 1 and the monitoring device 2 perform communications through wired connections separated from the network 5. The loads of the radio UPnP terminal 3, the UPnP terminal 6 and the network 5 do not increase at all. It is accordingly possible to prevent the increases of the power consumptions of the radio UPnP terminal 3 and the UPnP terminal 6 attributed to the monitoring, and the decreases of drive time periods in the case where the radio UPnP terminal 3 and the UPnP terminal 6 are driven by batteries. Besides, the radio UPnP terminal and the UPnP terminal in the related art can be respectively applied as the radio UPnP terminal 3 and the UPnP terminal 6 in the embodiment, directly without being altered.

Moreover the embodiment does not increase the loads of the network 5, the radio UPnP terminal 3 and the UPnP terminal 6 due to a periodic operation, so that the confirmation interval can be set sufficiently shorter than the available term, and the delay until the UPnP terminal 6 recognizes the detachment of the radio UPnP terminal 3 can be suppressed to a very short time.

Incidentally, the AP 1 and the monitoring device 2 may well be unitary. In this case, it is also allowed that the terminal-connection-information access unit 12 is omitted, and that the terminal-connection-information monitoring module 21 directly acquires the terminal connection information stored in the terminal-connection-information storage unit 11, every confirmation interval. Besides, in the embodiment, the AP 1 and the monitoring device 2 have been described as being connected by wire separately from the network 5, but they may well be connected through the network 5. In this case, the interval of the process operation S31 may well be lengthened in consideration of a load on the network 5.

Incidentally, although an AP is employed even in the technique of Patent Document 1, the information of a lower layer within the AP is not employed for the monitoring, but the AP is used merely as a device to which the terminal is connected by radio.

By the way, a first acquisition operation corresponds to the process operation S11 in the embodiment. Besides, a second acquisition operation corresponds to the process operations S12, S13 and S14 in the embodiment. Besides, a third acquisition operation corresponds to the process operations S31 and S32 in the embodiment. Further, a notification operation corresponds to the process operations S43, S44 and S45 in the embodiment. Still further, a storage operation corresponds to the process of the radio communication unit 13 in the embodiment.

Besides, a first acquisition portion and a second acquisition portion correspond to the UPnP monitoring module 22 in the embodiment. Besides, a third acquisition portion corresponds to the terminal-connection-information monitoring module 21 in the embodiment. Further, a notification portion corresponds to the terminal-connection-information translation module 24 and the UPnP notification module 25 in the embodiment. Yet further, a storage portion corresponds to the radio communication unit 13 in the embodiment.

Besides, the monitoring device according to the embodiment can be readily applied to a communication apparatus, and it can enhance the performance of the communication apparatus more. Here, the “communication apparatus” can cover, for example, a server, an AP and a network relay apparatus.

Further, a program which causes a computer constituting the monitoring device to execute the operations described above can be provided as a monitoring program. The program can be run by the computer constituting the monitoring device, when stored in a computer-readable record medium. Here, the computer-readable record medium covers a ROM, a RAM or the like internal storage device which is installed in the computer; a CD-ROM, a flexible disk, a DVD disk, a magneto optic disk, an IC card or the like portable storage medium; a database which retains computer programs; another computer and its database; a transmission medium on a network; and so forth.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A recording medium which bears a program for causing a computer to execute a monitoring control comprising:
receiving a first notification which has been transmitted from another communication apparatus to a network;
acquiring first identification information which is identification information of the communication apparatus at a predetermined first layer, from the first notification;
acquiring second identification information which is identification information of the communication apparatus at a second layer being lower in hierarchy than the first layer;
associating the first identification information and the second identification information;
acquiring a connection state between the network and the communication apparatus at the second layer;
generating a second notification which indicates that the communication apparatus has been detached from the network, on the basis of the first identification information corresponding to the second identification information, if the computer has judged the detachment of the communication apparatus from the network, on the basis of the connection state and the second identification information, and
transmitting the second notification to the network.

2. The recording medium which bears a program for causing a computer to execute a monitoring control as defined in claim 1, further comprising:
connecting the communication apparatus to the network through an access point which is connected to a monitoring device;
managing the second identification information and the connection state which are used for communications with the communication apparatus; and
acquiring the second identification information as the connection state between the network and the communication apparatus at the second layer from the access point.

3. The recording medium which bears a program for causing a computer to execute a monitoring control as defined in claim 2, further comprising:
transmitting a request for the second identification information to the access point; and
receiving the second identification information from the access point, at a predetermined time interval.

4. The recording medium which bears a program for causing a computer to execute a monitoring control as defined in claim 1, further comprising:
performing communications with the communication apparatus before receiving the first notification transmitted from the other communication apparatus to the network;
acquiring the second identification information;
storing the acquired information in a storage medium;
transmitting a request for the second identification information to the access point; and
receiving the second identification information from the access point, at a predetermined time interval.

5. The recording medium which bears a program for causing a computer to execute a monitoring control as defined in claim 4, comprising further:
transmitting a request for the second identification information to the access point; and
receiving the second identification information from the access point, at a predetermined time interval.

6. A monitoring device which is communicable with a communication apparatus, comprising:
a first acquisition portion which receives a first notification that has been transmitted from the communication apparatus to a network, and which acquires first identification information that is identification information of the communication apparatus at a predetermined first layer, from the first notification;
a second acquisition portion which acquires second identification information that is identification information of the communication apparatus at a second layer being lower in hierarchy than the first layer, and which associates the first identification information and the second identification information;
a third acquisition portion which acquires a connection state between the network and the communication apparatus at the second layer; and
a notification portion which generates a second notification indicating that the communication apparatus has been detached from the network, on the basis of the first identification information corresponding to the second identification information, in a case where the computer has judged the detachment of the communication apparatus from the network, on the basis of the connection state and the second identification information, and which transmits the second notification to the network.

7. A monitoring device as defined in claim 6, wherein:
the communication apparatus can be connected with the network through an access point which is connected to the monitoring device;
the access point manages the second identification information and the connection state which are used for communications with the communication apparatus; and
the third acquisition portion acquires the second identification information from the access point.

8. A monitoring device as defined in claim 7, wherein:
the third acquisition portion transmits a request for the second identification information to the access point and receives the second identification information from the access point, at a predetermined time interval.

9. A monitoring method in which a computer executes a monitoring control comprising:
receiving a first notification which has been transmitted from another communication apparatus to a network;
acquiring first identification information which is identification information of the communication apparatus at a predetermined first layer, from the first notification;
acquiring second identification information which is identification information of the communication apparatus at a second layer being lower in hierarchy than the first layer;
associating the first identification information and the second identification information;
acquiring a connection state between the network and the communication apparatus at the second layer;
generating a second notification which indicates that the communication apparatus has been detached from the network, on the basis of the first identification information corresponding to the second identification information, if the computer has judged the detachment of the communication apparatus from the network, on the basis of the connection state and the second identification information, and
transmitting the second notification to the network.
